(19) United States
(12) Patent Application Publication
(10) Pub. No.: US 2012/0328445 A1
(43) Pub. Date: Dec. 27, 2012

(54) GRIT BLAST FREE THERMAL BARRIER COATING REWORK

(75) Inventors: Neil B. Ridgeway, South Windsor, CT (US); Peter F. Gero, Portland, CT (US); Anthony Leonczyk, Ludlow, MA (US)

(73) Assignee: UNITED TECHNOLOGIES CORPORATION, Hartford, CT (US)

(21) Appl. No.: 13/169,606

(22) Filed: Jun. 27, 2011

(51) Int. Cl. B64C 27/46; B23P 6/00

(52) U.S. Cl. 416/224; 29/889.1

(57) ABSTRACT

A grit blast free method of removing a ceramic thermal barrier layer from a turbine component is described. The method comprises removing the layer in an autoclave with a caustic medium followed by a low pressure water jet wash. The component is dried in a stream of hot dry nitrogen and a new thermal barrier coating is applied before the component reenters product flow.

### BACKGROUND

The efficiency of a gas turbine power plant scales directly as the difference between the inlet and exhaust temperatures of the working fluid. As a result, great emphasis over the past half century has been focused on higher temperature materials, interior cooling circuits, and thermal barrier coatings (TBCs) on blades, vanes, and other turbine components.

Thermal barrier coatings offer insulative, mechanical, and thermal protection against the hot gas stream in the turbine. The coatings typically comprise an outer ceramic thermal barrier layer on a bond coat with an intermediate oxide layer between the ceramic thermal barrier layer and the bond coat. The ceramic layer is typically zirconium oxide stabilized with yttrium oxide. Common bond coats are a MCrAlY overlay coating where M is nickel, chrome, iron, or mixtures thereof, or a diffusion aluminide layer. An oxide (typically aluminum oxide) intermediate layer that is deposited on the bond coat or that forms as an oxidation product on the diffusion aluminide layer acts to strongly adhere the ceramic thermal barrier layer to the bond coat.

During the manufacturing process, it is sometimes necessary to rework or refurbish parts in the production line. In certain cases, it is necessary to remove part or all of the ceramic thermal barrier layer. Conventional methods of ceramic thermal barrier layer removal include combinations of caustic autoclave chemical removal at elevated pressures and temperatures, high pressure water jet, grit blast, and hydrofluoric acid removal. Prior art ceramic thermal barrier layer removal is described in commonly assigned U.S. Pat. No. 6,158,957 to Marcin et al. and incorporated herein by reference. The common prior art process includes a caustic solution treatment in an autoclave followed by grit blasting.

Care must be taken during abrasive ceramic thermal barrier layer removal on some internally cooled turbine components to not inject abrasive particles into cooling holes. This is a particular concern with some recent turbine components with advanced cooling circuits containing internal baffles. In this case, the grit is extremely difficult, if not impossible, to extract.

### SUMMARY

A grit blast free method of removing a ceramic thermal barrier layer comprises detaching the layer in an autoclave with a caustic medium and removing any remaining ceramic with a low-pressure (less than 20,000 psi) water jet wash. A stream of hot dry nitrogen dries the component and a new ceramic thermal barrier layer is applied before it reenters product flow.

### BRIEF DESCRIPTION OF THE DRAWINGS

FIG. 1 is a chart of the no grit blast ceramic thermal barrier layer restoration process.

### DETAILED DESCRIPTION OF THE PREFERRED EMBODIMENTS

There are periods in the manufacturing history of a part where rework needs to be adopted to adjust to recent configurational changes added to the part. An example is the removal of a ceramic thermal barrier layer on a turbine component such as a blade or vane with internal cooling circuitry. The component surfaces contain holes that direct cooling air over an airfoil surface to cool the blades and vanes in the hot gas path during operation.

Grit blasting is widely known in the art as a standard process to remove residual ceramic following caustic autoclave treatment of thermal barrier layers. During grit blasting, abrasive grit particles enter the cooling holes in the blade surface. In early stages of assembly, the grit particles can be removed by air or water streams blown from the surface into the blades where they can pass out the bottom of the blade through the intake ports of the cooling circuit. During later stages of assembly, however, baffles and other flow diverting components added to the cooling circuits block the reverse air flow and prevent any abrasive injected in the circuit by grit blasting to be backward flushed and removed. This invention is a grit blast free technique of ceramic thermal barrier layer removal and replacement for reworking a turbine component with interior cooling circuitry. It is to be understood that the process is not limited to turbine components and can be directed to any metallic substrate with a suitable ceramic oxide coating.

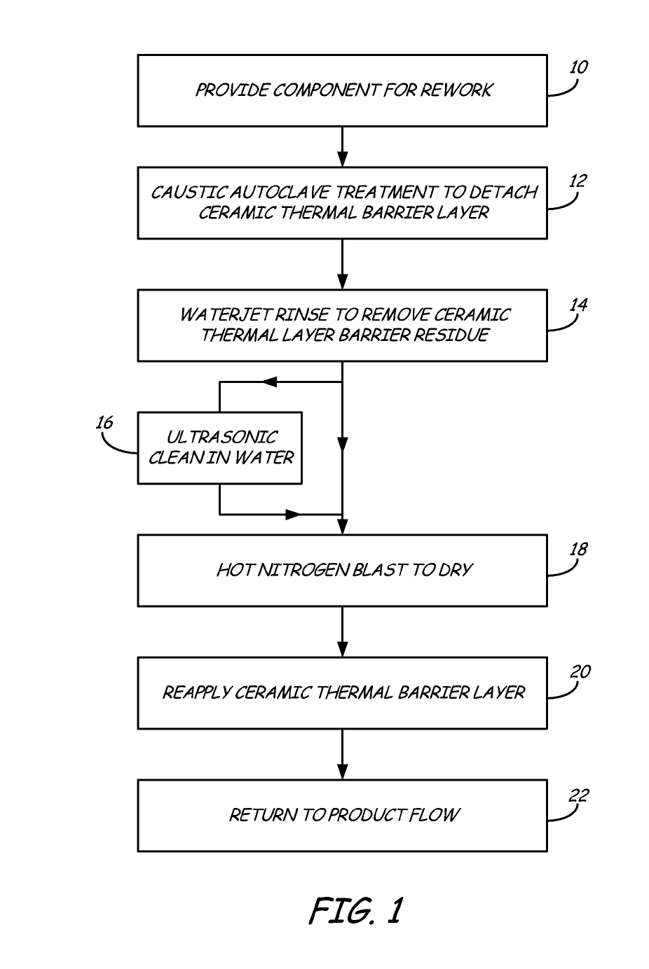

The grit blast free process is outlined in FIG. 1. To begin, a component with a ceramic thermal barrier coating requiring rework is provided (Step 10). In an embodiment for purposes of illustration only, the component is a turbine blade with a ceramic thermal barrier coating with internal cooling circuitry. The components are typically nickel or cobalt based superalloys such as PWA 1480, or others known in the art.

The thermal barrier coating typically comprises an outer ceramic thermal barrier layer disposed on an intermediate oxide layer that, in turn, is formed on a bond coat layer. The ceramic thermal barrier layer comprises a material such as zirconia, alumina, and others known for use as thermal barrier layers. The ceramic thermal barrier layer may be modified to include other ceramic materials such as yttria, ceria, scandia, and others known in the art. In one embodiment, the ceramic thermal barrier layer is zirconia stabilized with 7 wt. % yttria. In another embodiment, the ceramic thermal barrier layer is gadolina stabilized zirconia. The ceramic layer can be deposited by high velocity oxy fuel (HVOF) spraying, air plasma spraying (APS), low pressure plasma spraying (LPPS), or a physical vapor deposition technique e.g. electron beam physical vapor deposition (EBPVD) at appropriate substrate coating temperatures. In one embodiment, the stabilized zirconium oxide coating is formed by EBPVD, wherein the microstructure comprises strain tolerant columnar grains situated generally perpendicular to the substrate surface.

The ceramic thermal barrier layer is disposed on an intermediate ceramic oxide layer such as aluminum oxide, chromium oxide, and others. In one embodiment, the intermediate layer is aluminum oxide. The aluminum oxide layer can be formed on an aluminum containing bond coat by heating the bond coat in an oxidizing atmosphere to thermally grow the layer, or it can be directly deposited on the bond coat by chemical vapor deposition (CVD). The aluminum oxide intermediate layer protects the substrate from oxidation and provides strong adherence of the ceramic insulating layer to the bond coat.

The bond coat can be a MCrAlY layer (or overlay) where M is nickel, cobalt, iron, or mixtures thereof and/or a diffusion aluminide layer, which may be modified by additions of platinum or other metals. The MCrAlY layer can be deposited on the superalloy substrate or on the diffusion aluminide layer by plasma spray, EBPVD, sputtering, and other techniques known in the art. The diffusion aluminide layer can be deposited on the superalloy substrate or on a MCrAlY layer by CVD pack cementation and other deposition techniques known in the art.

The ceramic thermal barrier layer is removed by a caustic autoclave process in which the component is exposed to a caustic solution at an elevated temperature and pressure (Step 12). Suitable caustic solutions are aqueous solutions of about 10 wt. % to about 45 wt. % sodium hydroxide or potassium hydroxide at temperatures of from about 100° F. to about 400° F. Preferably about 45 wt. % sodium hydroxide or potassium hydroxide at a temperature of about 350° F. Suitable pressures are from about 100 psi to about 400 psi, preferably about 300 psi. Times of from 1 minute to 60 minutes are suggested whereas 30 minutes have been found to be preferred for complete ceramic removal.

There is evidence that the mechanism of ceramic thermal barrier removal is the dissolution of the aluminum oxide intermediate layer by the caustic solution in the autoclave. As a result, the layer lifts off or spalls during a subsequent water jet rinse. Following the caustic autoclave process, the component is given a water jet rinse to remove residual ceramic remaining on the surface (Step 14). Pressures of less than 20,000 psi have been found to be satisfactory to completely remove the ceramic coating from both the component surface and from the cooling holes. Careful examination indicated no degradation of the bond coat or of the cooling holes following caustic autoclave removal and water jet wash.

Optionally, the component may also be additionally ultrasonically cleaned in water (Step 16).

The next step is to dry the component in a hot dry nitrogen blast at a temperature of about 80° F. to about 250° F. and at a pressure of about 40 psi to 150 psi. (Step 18) Preferably about 150° F. and 80 psi.

Following drying, a new ceramic thermal barrier layer is applied to the component using one of the methods described earlier (Step 20). In one embodiment, the layer is applied by EBPVD. The component is reinserted into product flow (Step 22) following reapplication of the ceramic thermal barrier layer.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A grit blast free method of reworking a turbine engine component having a ceramic thermal barrier layer thereon comprising:
detaching the ceramic thermal barrier layer with a caustic medium;
cleaning the component with a low pressure water jet wash;
drying the component; and
applying a new ceramic thermal barrier layer on the component.

2. The method of claim 1, wherein the component is a blade or a vane.

3. The method of claim 1, wherein the caustic medium comprises a sodium hydroxide aqueous solution at elevated temperature and pressure in an autoclave.

4. The method of claim 1 wherein the caustic medium comprises a potassium hydroxide aqueous solution at elevated temperature and pressure in an autoclave.

5. The method of claim 1, wherein the water jet wash has a water pressure of less than 20,000 psi.

6. The method of claim 1, wherein drying the component comprises directing a stream of hot nitrogen gas at the component to evaporate water from the component.

7. The method of claim 1, and further comprising ultransonic cleaning in an aqueous solution after cleaning the component with a low pressure water jet wash and before drying the component.

8. The method of claim 1, wherein applying a new ceramic thermal barrier layer comprises one of electron beam physical vapor deposition, plasma deposition, or high velocity oxy-fuel deposition.

9. The method of claim 8, wherein applying a new ceramic thermal barrier layer comprises electron beam physical vapor deposition.

10. A grit blast free method for reworking a ceramic thermal barrier layer on a turbine engine component, the method comprising:
detaching the ceramic thermal barrier layer with a caustic solution at an elevated temperature and pressure in an autoclave;
cleaning the component with a low pressure water jet wash;
drying the component; and
applying a new ceramic thermal barrier layer to the component.

11. The method of claim 10, wherein the caustic solution comprises by weight between about 10% sodium hydroxide and about 45% sodium hydroxide and water.

12. The method of claim 10, wherein the autoclave pressure is between about 100 psi and about 400 psi and the temperature is between about 80° F. and about 350° F.

13. The method of claim 10, wherein the water jet pressure is less than 20,000 psi.

14. The method of claim 10, and further comprising an ultrasonic cleaning in a water bath after cleaning the component with a low pressure water jet wash.

15. The method of claim 11, wherein drying the component comprises directing a stream of hot nitrogen gas at the component to evaporate water from the component.

16. The method of claim 16, wherein the temperature of the nitrogen gas is between about 80° F. and about 250° F.

17. The method of claim 11, wherein applying a new ceramic thermal barrier layer comprises a new ceramic thermal barrier layer deposited by one of electron beam physical vapor deposition, plasma deposition, or high velocity oxy-fuel deposition.

18. The method of claim 11, wherein the thermal barrier coating comprises yttria stabilized zirconia.

19. The method of claim 19, wherein the thermal barrier layer is on an aluminum containing bond coat layer.

20. A refurbished turbine engine component produced by the method of claim 10.
